(19) United States
(12) Patent Application Publication
(10) Pub. No.: US 2025/0225647 A1
(43) Pub. Date: Jul. 10, 2025

(54) APPARATUS AND METHOD WITH DEFECT DETECTION

(71) Applicant: SAMSUNG ELECTRO-MECHANICS CO., LTD., Suwon-si (KR)

(72) Inventors: Dongjin PARK, Suwon-si (KR); Daun JEONG, Suwon-si (KR); Hansang CHO, Suwon-si (KR)

(73) Assignee: SAMSUNG ELECTRO-MECHANICS CO., LTD., Suwon-si (KR)

(21) Appl. No.: 18/625,556

(22) Filed: Apr. 3, 2024

(30) Foreign Application Priority Data
Oct. 23, 2023 (KR) 10-2023-0142092
Jan. 8, 2024 (KR) 10-2024-0002745

(51) Int. Cl. G06T 7/00; G01N 21/88; G06V 10/74; G06V 10/764; G06V 10/77; G06V 10/774

(52) U.S. Cl. CPC G06T 7/001; G01N 21/8851; G06V 10/761; G06V 10/764; G06V 10/7715; G06V 10/774; G01N 2021/8854; G01N 2021/8887; G01N 2201/126; G06T 2207/20081

(57) ABSTRACT

A processor-implemented defect detection method are provided. The defect detection method includes generating a plurality of text data by adding a plurality of candidate classes which indicate whether a product is defective to product text information; and detecting whether a product image represents a defective product using an image model provided the product image, and a text model provided the plurality of text data.

### CROSS-REFERENCE TO RELATED APPLICATIONS

This application claims the benefit under 35 USC § 119 (a) of Korean Patent Application No. 10-2024-0002745 filed on Jan. 8, 2024, and Korean Patent Application No. 10-2023-0142092 filed on Oct. 23, 2023, in the Korean Intellectual Property Office the entire disclosure of which is incorporated herein by reference for all purposes.

### BACKGROUND

### 1. Field

The following description relates to an apparatus and method with defect detection.

### 2. Description of Related Art

Image-based defect detection systems with artificial intelligence (AI) technology have been. Compared to existing defect detection methods that use rule-based algorithms, since an AI model may be learned using images of good products and defective products using ground truths that are mostly identified by a user, such an AI-based defect detection system may have an advantage of enabling product inspection with performance related to actual human judgment standards.

An AI-based defect detection system may use a model learned with training data including images and such determined ground truth labels, and the learned model may predict a classification corresponding to the input image. In this example, the learned model can only classify the given image into one of the predetermined labels.

Attempts have been made to improve inspection performance by using information other than images, but only numerical item values that such an existing AI model may recognize have been used when the AI models are machine learning, such as multi-layer perceptron (MLP) or restricted Boltzman machine (RBM) architectures. Additionally, because the range or unit of each numerical item value is different, separate preprocessing is typically desired in such AI models to divide each numerical item value by the maximum value to have a value between 0 and 1, and if some of the training data was missing with regard to such real world structures or use, the model typically cannot be used or the performance of the model varies significantly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented defect detecting method includes generating a plurality of text data by adding a plurality of candidate classes, which indicate whether a product is defective, to product text information; and detecting whether a product image represents a defective product using an image model provided the product image, and a text model provided the plurality of text data.

The detecting of whether the product image represents a defective product may include calculating respective similarities between a first feature map generated by the image model and a plurality of second feature maps generated by the text model; and determining whether the product is defective based on the calculated respective similarities.

The determining of whether the product represents a defective product may include calculating respective similarities between each of the plurality of second feature maps and the first feature map; calculating respective similarities between each of the plurality of second feature maps and the first feature map; outputting a candidate class comprised in text data corresponding to a highest score among the corresponding scores.

The product text information may include at least one of customer company information, production area information for the product, factory information for the product, product line information for the product, process information for the product, external environment information for the product, and inspection surface information for the product.

Each of the plurality of candidate classes may include information indicating whether the product is defective, and a defect type of the product.

The product text information may include a plurality of information that identifies the product, and wherein the plurality of information and the candidate class of the plurality of candidate classes included in each text data may be distinguished by a special character.

The method may further include training the image model and the text model using a plurality of training data, wherein each of the plurality of training data may include a pair that includes text data and a product image, and the training text data comprises product text information and a ground truth label.

The training of the image model and the text model may include calculating a similarity between a third feature map for the trained product image output from the image model and a fourth feature map for the training text data output from the text model; and training the image model and the text model to increase the similarity between the third feature map and the fourth feature map through plural training iterations.

In a general aspect, an apparatus includes one or more processors configured to generate a plurality of text data by combining each of a plurality of candidate classes with product text information; generate a first feature map using an image model based on a product image; generate a plurality of second feature maps using a text model based on the plurality of text data; and detect whether the product image represents a defective product based on a determined similarity between each of the plurality of second feature maps and the first feature map.

The product text information may include at least one of customer company information, production area information for the product, factory information for the product, product line information for the product, process information for the product, external environment information for the product, and inspection surface information for the product.

The customer company information may include defect inspection standard information of a customer company, and the external environment information of the product may include lighting condition information.

Each of the plurality of candidate classes may include information indicating whether the product is defective, and a defect type of the product.

The classifier may be configured to convert the similarity between each of the plurality of second feature maps and the first feature map into a score based on a softmax function, and output a candidate class corresponding to a highest score among the converted score as a result of whether the product image is defective.

The one or more processors may be further configured to train the image model and the text model using a plurality of training data consisting of pairs of respective training text data and training product image through a minimization of a loss calculated from a similarity between a third feature map for the training product image output from the image model and a fourth feature map for the training text data output from the text model, respectively, wherein the training text data may include the product text information and a ground truth label

The one or more processors may be further configured to determine a plurality of candidate classes based on decision information.

The decision information may include defect type information and defect status information.

The user-specific product text information may include at least one of customer company information, production area information, factory information, product line information, process information, external environment information, and inspection surface information.

The customer company information may include defect inspection standard information of a customer company.

In a general aspect, an apparatus includes processors configured to train an image model, using product text data and product images, to generate a first feature map; train a text model, using the product text data, to generate a second feature map; and train a classifier to convert a determined similarity between the first feature map and the second feature map into a class score that is indicative of whether a product is defective, wherein the image model, the text model, and the classifier are trained together.

The product text data may include at least one of customer company information, production area information for the product, factory information for the product, product line information for the product, process information for the product, external environment information for the product, and inspection surface information for the product.

Other features and aspects will be apparent from the following detailed description, the drawings, and the claims.

### BRIEF DESCRIPTION OF DRAWINGS

FIG. 1 illustrates an example computing apparatus, in accordance with one or more embodiments.

FIG. 2 illustrates an example of a plurality of text data, in accordance with one or more embodiments.

FIG. 3 illustrates a specific example of a plurality of text data, in accordance with one or more embodiments.

FIG. 4 illustrates an example product image.

FIG. 5, FIG. 6, and FIG. 7 are illustrate deviations in product images, respectively, in accordance with one or more embodiments.

FIG. 8 illustrates a method with image model and text model training, in accordance with one or more embodiments.

FIG. 9 illustrates a method with detect defection, in accordance with one or more embodiments.

FIG. 10 is a flowchart illustrating a method with defect detection, in accordance with one or more embodiments.

FIG. 11 illustrates an example electronic device, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In or more examples, an apparatus or method with defect detection may improve defect detection performance over existing approaches, such as other rule-based existing approaches, for example.

In the actual inspection processes, there is a variety of information that may be needed to detect the occurrence of defects and features, and detection performance may be improved when the model performs prediction by using this information together with the image.

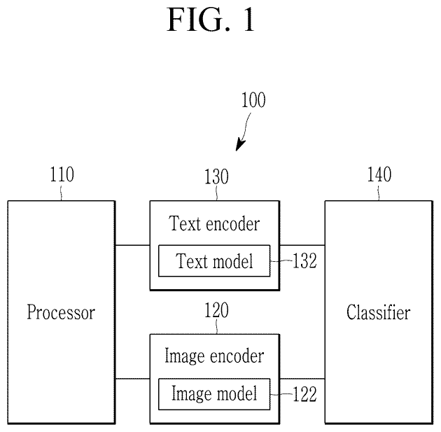

FIG. 1 illustrates an example computing apparatus, in accordance with one or more embodiments.

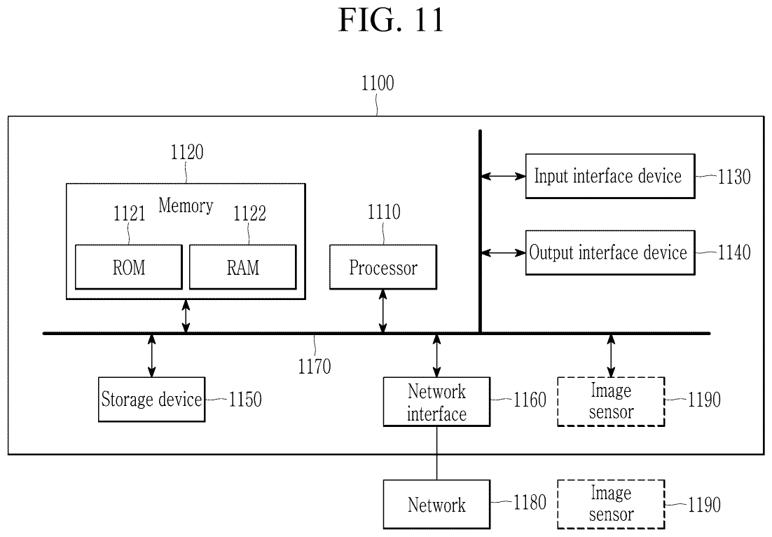

Referring to FIG. 1, the example computing apparatus 100 may include a processor 110, an image encoder 120, a text encoder 130, and a classifier 140. In an example, the processor 110 may include one or more processors. Each of the image encoder 120, text encoder 130, and classifier 140 may be representative of one or more processors. In one or more examples, respective operations of any one or any combination of the image encoder 120, the text encoder 130, and the classifier 140 may be performed by the processor 110. The processor 110 is also representative of one or more memories. As a non-limited example, the computing apparatus 100 may be the electronic device 1100 of FIG. 11.

The computing apparatus 100 may be implemented in various electronic devices, which may be, or include, a personal computer, computer workstation, smartphone, tablet computer, or the like, without being limited in the disclosed examples.

The computing apparatus 100 may be applied to different systems or devices. For example, the computing apparatus 100 may be connected to an execution device such as a terminal, such as a mobile phone terminal, a tablet computer, a notebook computer, or the like.

In an example, the processor 110 may receive a target product image (or specimen image) and various product text information related to the target product image from the user. The processor 110 may receive decision information from the user, and store the received decision information.

In an example, the target product image may be a photograph (e.g., by an image sensor of the electronic device 1100 of FIG. 11). In an example, a bump pad may be photographed to detect a defect of the bump pad. The image sensor may be, as only examples, a charge coupled device (charge coupled device, CCD) camera, or may be another camera or video camera, without being limited thereto.

The processor 110 may provide a product image to the image encoder 120.

The processor 110 may generate a plurality of text data to be input to the text encoder 130 based on product text information and decision information received from the user.

The processor 110 may provide a plurality of text data to the text encoder 130.

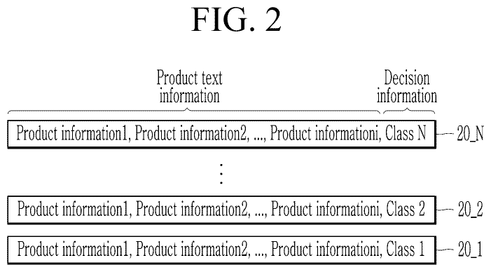

FIG. 2 illustrates an example of a plurality of text data.

Referring to FIG. 2, the decision information may include information about a decision target to be determined. In an example, in the example of a classification problem, the decision target may be classified into one of a plurality of candidate classes (class 1 to class N). The decision information may include classification type information representing a plurality of candidate classes of Class 1 to Class N.

In an example, the processor 110 may generate a plurality of candidate classes of Class 1 to Class N based on the decision information.

The processor 110 may generate a plurality of text data 20_1 to 20_N by adding each of a plurality of candidate classes of Class 1 to Class N to the product text information.

Specifically, the processor 110 may generate text data 20_1 by adding a candidate class of Class 1 to the product text information, and generate text data 20_2 by adding a candidate class of Class 2 to the product text information. Accordingly, the plurality of text data 20_1 to 20_N may be generated. That is, the product text information may be the same in the N pieces of text data 20_1 to 20_N, and the candidate classes of Class 1 to Class N in the N pieces of text data 20_1 to 20_N may be different. Therefore, N pieces of text data 20_1 to 20_N may be distinguished through candidate classes of Class 1 to Class N.

As an example, product text information includes product information 1, product information 2, . . . , and product information i. As a more specific example, product text information may include at least one of all information related to defect detection from product images, such as customer company information, production area information, factory information, product line (group) information, process information, external environment information, and inspection surface information.

In an example, the plurality of product information included in product text information may be distinguished by a special character. As an example, a comma (,) may be used as the special character. As another example, a colon (:) or a hatch (/) may be used as the special character.

In the plurality of text data 20_1 to 20_N, each candidate class of Class 1 to Class N may be added after the plurality of product information included in the product text information. Additionally, product text information and candidate classes may also be distinguished by the special character.

Referring again to FIG. 1, the image encoder 120 may generate a feature map from the product image. The image encoder 120 may generate the feature map from the product image by implementing an image model 122. The image model 122 may be trained in one or more embodiments. The image model 122 may receive a product image as input, extract features from the product image, and generate a feature map from the extracted features. The feature map may refer to a set of features. That is, the image model 122 may output the feature map corresponding to the product image. In an example, the feature map of the target image may include an image information feature map. Optionally, the image information feature map may be, as examples, a point feature, line feature, surface feature and/or color feature in the target image.

The text encoder 130 may generate a feature map for each of a plurality of text data. The text encoder 130 may generate a feature map for each of a plurality of text data using a text model 132. The text model 132 may be trained in one or more embodiments. The text model 132 may receive a plurality of text data. The text model 132 may extract features for each of a plurality of received text data and generate a feature map for each of the plurality of text data from the extracted features. The text model 132 may output the feature map for each of a plurality of text data.

The classifier 140 may detect one of the candidate classes as a final class using the feature map received from the image encoder 120 and the plurality of feature maps received from the text encoder 130.

The classifier 140 may calculate the similarity between the feature map received from the image encoder 120 and each feature map received from the text encoder 130, and detect the final class based on the calculated similarities.

Below, for the purpose of distinguishing between the feature map output from the image encoder 120 and the feature map output from the text encoder 130, the feature map output from the image encoder 120 is referred to as the “first feature map” and the feature map output from the encoder 130 is called a “second feature map.”

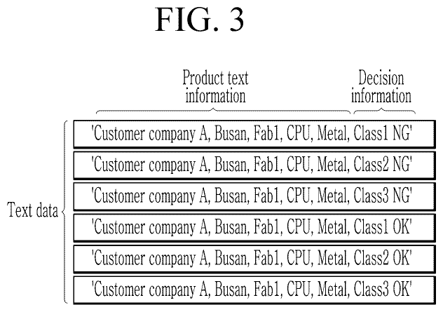

FIG. 3 illustrates a specific example of a plurality of text data. As a non-limited example, the plurality of text data may be generated by the processor 110 of FIG. 1.

Referring to FIG. 3, product text information may include customer company information of Customer company A, production area information of Busan, factory information of Fab1, product line information of CPU, and process information of Metal, as non-limiting examples.

When determining whether a product is defective based on a defect type, the decision information may include defect type information and defect status information. The defect type information may include Class1, Class2, and Class3. The defect status information may include NG and OK. In an example, OK may indicate normal, and NG may indicate defective.

The i processor may generate a plurality of candidate classes, such as Class1 NG, Class2 NG, Class3 NG, Class1 OK, Class2 OK, Class3 OK using the decision information. The processor may receive decision information from the user. Alternatively, the input processor may store decision information.

The processor may generate one text data including Customer company A, Busan, Fab1, CPU, Metal, and Class1 NG by adding the candidate class of Class1 NG to the product text information of Customer company A, Busan, Fab1, CPU, and Metal.

The processor may generate one text data including Customer company A, Busan, Fab1, CPU, Metal, and Class2 NG by adding the candidate class of Class2 NG to the product text information of Customer company A, Busan, Fab1, CPU, and Metal.

The processor may generate one text data including Customer company A, Busan, Fab1, CPU, Metal, and Class3 NG by adding the candidate class of Class3 NG to the product text information of Customer company A, Busan, Fab1, CPU, and Metal.

The processor may generate one text data including Customer company A, Busan, Fab1, CPU, Metal, and Class1 OK by adding the candidate class of Class1 OK to the product text information of Customer company A, Busan, Fab1, CPU, and Metal.

The processor may generate one text data including Customer company A, Busan, Fab1, CPU, Metal, and Class2 OK by adding the candidate class of Class2 OK to the product text information of Customer company A, Busan, Fab1, CPU, and Metal.

The processor may generate one text data including Customer company A, Busan, Fab1, CPU, Metal, and Class3 OK by adding the candidate class of Class3 OK to the product text information of Customer company A, Busan, Fab1, CPU, and Metal.

Accordingly, the processor may generate a plurality of text data by adding each candidate class of Class1 NG, Class2 NG, Class3 NG, Class1 OK, Class2 OK, and Class3 OK to the product text information of Customer company A, Busan, Fab1, CPU, and Metal. Each candidate class of Class1 NG, Class2 NG, Class3 NG, Class1 OK, Class2 OK, and Class3 OK may be used as identification information to distinguish the plurality of text data.

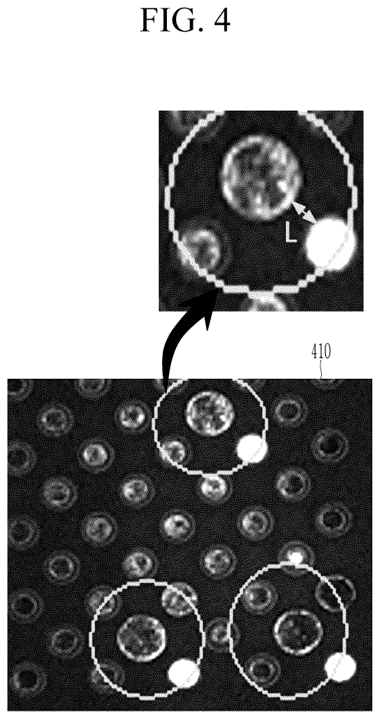

FIG. 4 illustrates an example product image, in accordance with one or more embodiments.

Referring to FIG. 4, a product image 410 represents a photographed image (e.g., an image photographed by an image sensor of the electronic device 1100 of FIG. 11) of the CPU board bump pad of a server PC.

It is assumed that the product image 410 is disposed as illustrated in FIG. 4, and that the defect detection item is a large bump pad. In this example, a defect in the large bump pad may be detected based on the distance L between bumps or based on the size of the bump.

However, the defect inspection standards for various companies may be different from each other. For example, customer company A may determine that a defect occurs when there are two or more bumps where the distance L between bumps is less than 150 μm. In contrast, customer company B may determine that a product is defective when there is one or more bumps which have a size that is larger than a set ratio. Furthermore, customer company C may determine that a product is defective when there are three or more bumps where the distance L between bumps is less than 100 um.

Accordingly, the inspection standards for determining product defects may differ depending on the customer company. However, if defects are detected using only product images without considering the defect inspection standard of the customer company, it may be difficult to detect defects suitable for the defect inspection standard of the specific customer company. In an example, if the defect inspection standards of the customer company are recognized by the machine-learning model, defect detection suitable for the defect inspection standard of the specific customer company is possible.

Therefore, in an example, the defect detection performance of the computing apparatus 100, as a non-limiting example, may be improved by providing the specific information of the customer company, for example, the defect inspection standards of the customer company as product text information.

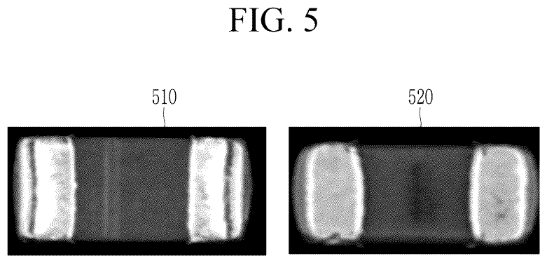

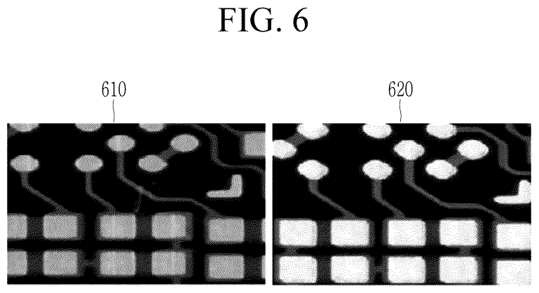

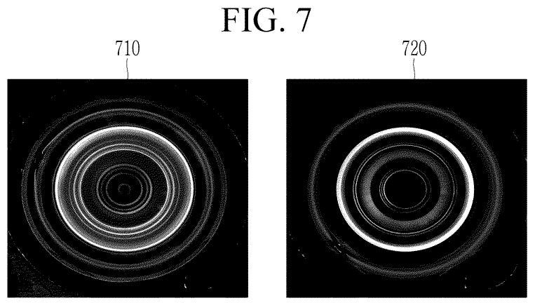

FIGS. 5 to 7 are diagrams illustrating deviations in product images, respectively.

Referring to FIG. 5, product images 510 and 520 represent photographed images (e.g., by an image sensor of the electronic device 1100 of FIG. 11) of multilayer ceramic condensers with different capacities, respectively.

In the example of a multilayer ceramic condenser, the shape (size) may vary depending on capacity. Accordingly, the product images 510 and 520 of the multilayer ceramic condensers may also have different shapes.

If defects are detected using only product images without considering the capacity information of the product when inspecting defects, a normal non-defective product may be detected as defective depending on the size conditions of the set product image.

Therefore, according to an embodiment, the defect detection performance of the computing apparatus 100 may be improved by providing product line information, such as capacity information of the product, as product text information (or as a part of the product information) along with the product image.

Additionally, substrates may be produced under various process conditions such as, but not limited to, lamination, plating, and delamination, and even if at least one of the various process conditions is changed, color differences in the product image may occur.

In FIG. 6, product images 610 and 620 represent images photographed (e.g., by an image sensor of the electronic device 1100 of FIG. 11) of mobile phone substrates produced under different plating conditions.

Referring to FIG. 6, although the product images 610 and 620 are images of the same product produced under different process, or plating, conditions, color differences may occur between the product images 610 and 620. Accordingly, when defects are detected using only product images, a normal product may be detected as being defective.

Therefore, according to an embodiment, the defect detection performance of the computing apparatus 100 may be improved by providing process (or product textual information) information along with the product image. Specifically, the one or more examples may enhance the sensitivity of a detection neural network to the type of defect, and in turn, increase the accuracy of detecting some specific defect types by the detection neural network, and increase accuracy of defect detection.

Additionally, differences in product images may occur due to changes in the external environment. For example, when photographing a product, lighting settings may be changed to make certain defects more visible. If a specific defect becomes an issue while photographing under lighting condition A, in order to observe the defect in detail, the product may be photographed by changing the lighting condition to lighting condition B. Accordingly, product images may also vary depending on the lighting that is being used when the product is photographed.

In FIG. 7, product images 710 and 720 represent photographed images (e.g., by an image sensor of the electronic device 1100 of FIG. 11) of a mobile phone camera module captured under different lighting conditions, respectively.

Referring to FIG. 7, if lighting conditions are set differently even for the same product, a brightness difference may occur between the product images 710 and 720, which are photographic images of the same product. Accordingly, when defects are detected using only product images, normal products may be detected as being defective.

Therefore, according to an embodiment, the defect detection performance of the computing apparatus 100 may be improved by providing external environment information such as lighting information as product text information along with the product image.

Furthermore, according to an embodiment, all condition information affecting the product, such as customer company information, process information, and external environment information, as well as production area information, factory information, and product line information, may be added to the product text information, and by learning this product text information along with the product image in the machine-learning model such as the image model 122 and the text model 132, the detection accuracy of the machine-learning model may be increased. Specifically, the one or more examples may enhance the sensitivity of a detection neural network to the spatial position, and in turn, increasing accuracy of detecting some specific defect types by the detection neural network, and increasing accuracy of defect detection.

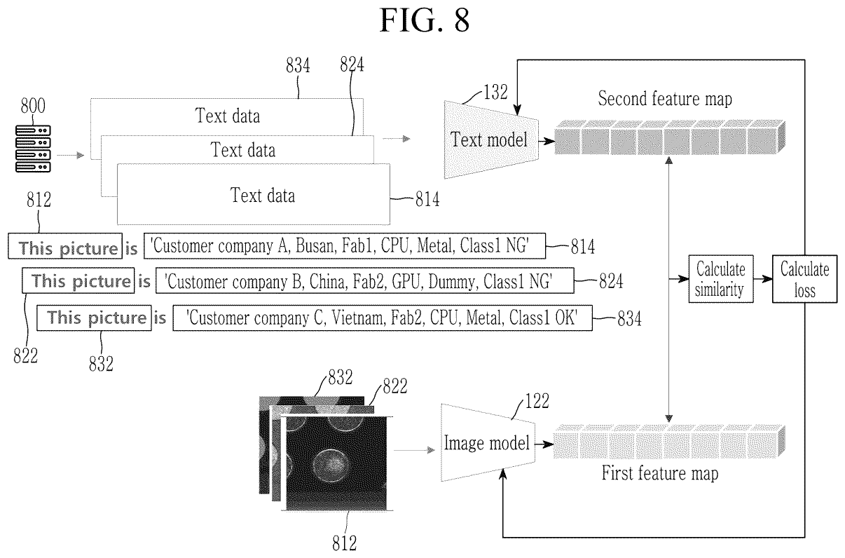

FIG. 8 illustrates a method with an image model and a text model training, in accordance with one or more embodiments.

Referring to FIG. 8, the ground truth (correct answer) label consists of a normal indication of “OK”, and a defective indication of “NG” for each class of defect type.

Referring to FIG. 8, a plurality of training data may be stored in the database 800.

In the training data, text data and product images may be composed of pairs of data. For example, the text data may include product text information and a ground truth (i.e., a correct answer) label. The ground truth label may indicate whether or not the defect type is defective for the product image.

For example, the product image 812 may be paired with text data 814, and the text data 814 may include product text information of Customer company A, Busan, Fab1, CPU, and Metal and the ground truth label of Class1 NG. The product image 822 may be paired with text data 824, and the text data 824 may include product text information of Customer company B, China, Fab2, GPU, and Dummy and the ground truth label of Class2 NG. Additionally, the product video 832 may be paired with text data 834, and the text data 834 may include product text information of Customer company C, Vietnam, Fab3, CPU, and Metal and the ground truth label of Class1 OK. In FIG. 8, only three training data are shown for convenience.

The image model 122 and the text model 132 may be trained using training data, respectively. In an example, the image model 122 and the text model 132 may be trained using the same pair of text data 814, 824, and 834 and the respective product images 812, 822, and 832. While the image model 122 and the text model 132 may be trained together, examples are not limited thereto, as the image model 122 and the text model 132 may also be respectively trained separately, such as before the image model 122 and the text model 132 are trained together.

Moreover, training the image model 122 and the text model 132 together may increase the processing speed.

Specifically, the same pair of product images 812 and text data 814 may be input to the image model 122 and the text model 132, respectively.

The image model 122 may output a first feature map from the product image 812.

The text model 132 may output a second feature map from the text data 814.

The similarity between the first feature map output from the image model 122 and the second feature map output from the text model 132 based on the text data 814 may be calculated, and a loss may be calculated based on the similarity. The loss may be defined as the difference between the similarity between the first feature map and the second feature map and a set target value.

The calculated loss may be used to train the image model 122 and the text model 132, such as through respective back propagations of the loss back through the image model 122 and the text model 132.

The training of the image model 122 may be performed to generate the first feature map for the product image 812 in a manner that minimizes the loss through iterative adjustments of parameters (e.g., weights) through back propagations of respectively calculated losses.

The training of the text model 132 may be performed to generate the second feature map for the text data 814 in a manner that minimizes the loss through iterative adjustments of parameters (e.g., weights) through back propagations of respectively calculated losses.

During each corresponding iteration, a respective same pair of product image 822 and text data 824 may be input to the image model 122 and the text model 132, and the image model 122 may be trained to generate a first feature map for the product image 822 in a manner that minimizes the loss, and the text model 132 may be trained to generate the second feature map for the text data 824 in a manner that minimizes the loss, as described above.

Similarly, during each corresponding iteration, a respective same pair of product image 832 and text data 834 may be input to the image model 122 and the text model 132, and the image model 122 may be trained to generate a first feature map for the product image 832 in a manner that minimizes the loss, and the text model 132 may be trained to generate the second feature map for the text data 834 in a manner that minimizes the loss, as described above.

When the image model 122 and the text model 132 have been trained, the similarity between the first feature map and the second feature map output from the same pair of product image and text data may have a value that is close to the target value.

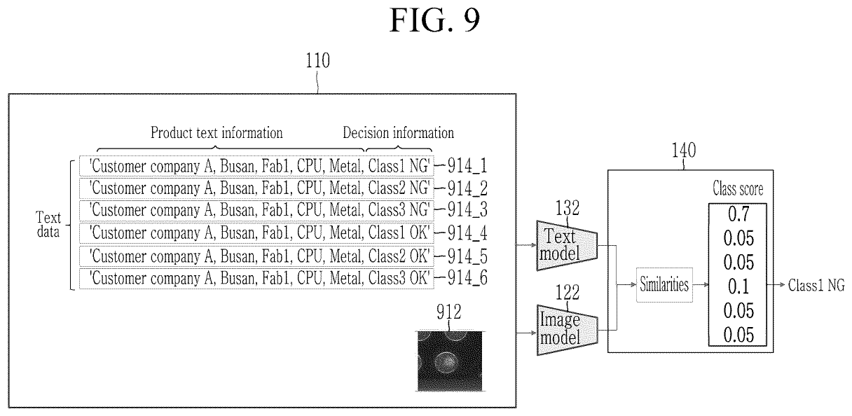

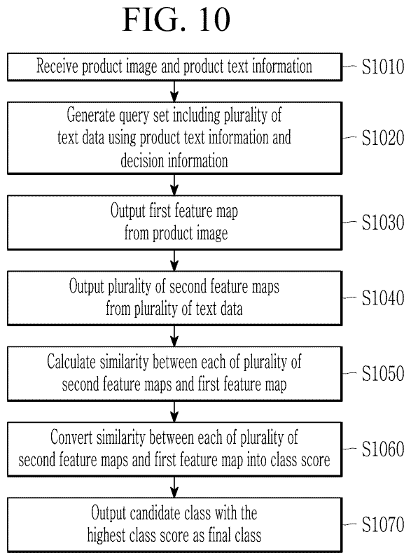

FIGS. 9 and 10 respectively illustrate methods with defect detection, in accordance with one or more embodiments. The operations in FIG. 10 may be performed in the sequence and manner as shown. However, the order of some operations may be changed, or some of the operations may be omitted, without departing from the spirit and scope. Additionally, some operations illustrated in FIG. 10 may be performed in parallel or simultaneously. In an example, the descriptions of FIGS. 1-9 may also be applicable to FIG. 10 and are incorporated herein by reference. Thus, the above description may not be repeated here for brevity purposes.

Referring to FIGS. 9 and 10, the processor may receive a product image 912, that is a decision target, and product text information from the user (operation S1010). The processor may receive decision information from the user. The decision information may be stored in the processor, such as in a memory of the processor, or in a memory of an electronic device that includes the processor, such as the electronic device 1100 of FIG. 11. In an example, the processor may be the processor 110 of FIG. 1, although the examples are not limited thereto.

The processor may generate a query set including a plurality of text data 914_1, 914_2, 914_3, 914_4, 914_5, and 914_6 using product text information and decision information (operation S1020).

In an example, product text information may include customer information of Customer company A, production area information of Busan, factory information of Fab1, product line information of CPU, and process information of Metal. In an example, the processor 110 may generate a plurality of candidate classes of Class1 NG, Class2 NG, Class3 NG, Class1 OK, Class2 OK, and Class3 OK using decision information. In an example, as described in FIG. 3, the processor 110 may generate a plurality of text data 914_1, 914_2, 914_3, 914_4, 914_5, and 914_6 by adding each candidate class of Class1 NG, Class2 NG, Class3 NG, Class1 OK, Class2 OK, and Class3 OK to the product text information of Customer company A, Busan, Fab1, CPU, and Metal.

The processor may input the query set including the plurality of text data 914_1, 914_2, 914_3, 914_4, 914_5, and 914_6 into a text model, such as the text model 132 and input the product image 912 into an image model, such as the image model 122.

The image model may output the first feature map from the product image 912 (operation S1030).

The text model may output a plurality of second feature maps from the plurality of text data 914_1, 914_2, 914_3, 914_4, 914_5, and 914_6 (operation S1040).

A classifier, such as the classifier 140, may calculate a similarity between each of the plurality of second feature maps and the first feature map (operation S1050).

The classifier may convert the similarity between each of the plurality of second feature maps and the first feature map into each class score indicating the probability for each candidate class (operation S1060). The classifier may convert the similarity into a class score using the softmax function.

When the total number of candidate classes is k, the similarities between the first feature map and the k second feature maps may be input to the softmax function as a k-dimensional vector. If the i-th element in a k-dimensional vector is represented as zᵢ and the probability that the i-th candidate class is the ground truth is represented as Pᵢ, the softmax function may be defined as Equation 1 below.

$${p}_{i} = \frac{{e}^{{z}_{1}}}{{\sum }_{j = 1}^{k} {e}^{{z}_{j}}} for i = 1 , 2 , … k \qquad Equation 1$$

In an example, when k=3, if the 3-dimensional vector z=[z1 z2 z3] may be input to the softmax function, the softmax function may return an output such as Equation 2 below.

$$soft max ( z ) = [ \frac{{e}^{{z}_{1}}}{{\sum }_{j = 1}^{3} {e}^{{z}_{j}}} \frac{{e}^{{z}_{2}}}{{\sum }_{j = 1}^{3} {e}^{{z}_{j}}} \frac{{e}^{{z}_{3}}}{{\sum }_{j = 1}^{3} {e}^{{z}_{j}}} ] = [ {p}_{1} , {p}_{2} , {p}_{3} ] \qquad Equation 2$$

Here, p₁, p₂, and p₃ may represent the probability that candidate class 1 is the ground truth, the probability that candidate class 2 is the ground truth, and the probability that candidate class 3 is the ground truth, and each may have a value between 0 and 1, and the total sum may be 1.

The classifier may detect one candidate class as the final class based on each class score. The classifier may output the candidate class with the highest class score as the final class (operation S1070).

In an example, as illustrated in FIG. 9, when the output of the softmax function for the similarity between each of the plurality of second feature maps and the first feature map is [0.7, 0.05, 0.05, 0.1, 0.05, 0.05], since 0.7 is the largest value, “Class1 NG”, which is the candidate class of the first text data corresponding to 0.7, may be output as the final class. That is, the product image 912 may be detected as defective for defect type Class1.

FIG. 11 illustrates an example electronic device, in accordance with one or more embodiments.

Referring to FIG. 11, the electronic device 1100 may be, or include, a computing apparatus, such as any of the computing apparatuses discussed above with respect to FIGS. 1-10, and thus, may be configured to perform any one or any combination of the operations or methods described above with respect to FIGS. 1-10.

The electronic device 1100 may include one or more of each of a processor 1110, and a memory 1120. The electronic device 1100 may further include at least one of input interface device 1130, output interface device 1140, storage device 1150, or network interface device 1160. Each component may be connected by a bus 1170 and may communicate with each other. Additionally, each component may be connected through an individual interface or an individual bus centered on the processor 1110, as a non-limiting example, rather than the common bus 1170.

The processor 1110 may be implemented as various types such as an application processor (AP), a central processing unit (CPU), a graphics processing unit (GPU), etc., and may be any semiconductor device that executes instructions (e.g., computer-readable code or program) stored in the memory 1120 or the storage device 1150. The processor 1110 may execute such instructions stored in at least one of the memory 1120 and the storage device 1150. The processor 1110 may execute such instructions, stored in the memory, which thereby configures the processor 1110 to perform the operations of processor 110, image encoder 120, text encoder 130, and classifier 140 described in FIGS. 1 to 10. In an example, the processor 1110 may be the processor 110 described above with respect to FIGS. 1-10, as a non-limited example.

The memory 1120 and storage device 1150 may include various types of volatile or non-volatile storage media. For example, the memory 1120 may include read-only memory (ROM) 1121 and random-access memory (RAM) 1122. The memory 1120 may be disposed inside and/or outside the processor 1110, and the memory 1120 may be connected to the processor 1110 through various known means.

The input interface device 1130 may be configured to provide input data to the processor 1110. In some embodiments, the input interface device 1130 may provide product image and product text data to the processor 1110.

The output interface device 1140 may be configured to output data from the processor 1110. In some embodiments, output interface device 1140 may output the final class.

The network interface device 1160 may transmit or receive signals to and from external devices through a wired network and/or wireless network 1180.

Additionally, at least some of the defect detection method according to embodiments may be implemented as hardware that may be electrically connected to a computing device.

A detection accuracy of an example AI model according to one or more embodiments may be increased over previous approaches through the learning of using various product text information, which may affect defect inspection, along with product images during defect inspection, and accordingly, defect detection performance may be improved through the use of such one or more example AI models according to one or more embodiments.

The processor 110, text encoder 130, image encoder 120, classifier 140, processor 1110, memory 1120, input interface device 1130, output interface device 1140, storage device 1150, network interface device 1160, image sensor 1190, and other processors, memories, and communication interfaces described herein, including corresponding and other descriptions herein with respect to FIGS. 1-11, are implemented by, or representative of, hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations).

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented defect detecting method, the method comprising:
generating a plurality of text data by adding a plurality of candidate classes, which indicate whether a product is defective, to product text information; and
detecting whether a product image represents a defective product using an image model provided the product image, and a text model provided the plurality of text data.

2. The method of claim 1, wherein the detecting of whether the product image represents a defective product comprises:
calculating respective similarities between a first feature map generated by the image model and a plurality of second feature maps generated by the text model; and
determining whether the product is defective based on the calculated respective similarities.

3. The method of claim 2, wherein the determining of whether the product represents a defective product comprises:
calculating respective similarities between each of the plurality of second feature maps and the first feature map;
converting the respective similarities between each of the plurality of second feature maps and the first feature map into corresponding scores; and
outputting a candidate class comprised in text data corresponding to a highest score among the corresponding scores.

4. The method of claim 1, wherein the product text information comprises at least one of customer company information, production area information for the product, factory information for the product, product line information for the product, process information for the product, external environment information for the product, and inspection surface information for the product.

5. The method of claim 1, wherein each of the plurality of candidate classes comprise information indicating whether the product is defective, and a defect type of the product.

6. The method of claim 1
wherein the product text information comprises a plurality of information that identifies the product, and
wherein the plurality of information and the candidate class of the plurality of candidate classes included in each text data are distinguished by a special character.

7. The method of claim 1, further comprising:
training the image model and the text model using a plurality of training data,
wherein each of the plurality of training data comprises a pair that includes text data and a product image, and the training text data comprises product text information and a ground truth label.

8. The method of claim 7, wherein the training of the image model and the text model comprises:
calculating a similarity between a third feature map for the trained product image output from the image model and a fourth feature map for the training text data output from the text model; and
training the image model and the text model to increase the similarity between the third feature map and the fourth feature map through plural training iterations.

9. An apparatus comprising:
one or more processors configured to:
generate a plurality of text data by combining each of a plurality of candidate classes with product text information;
generate a first feature map using an image model based on a product image;
generate a plurality of second feature maps using a text model based on the plurality of text data; and
detect whether the product image represents a defective product based on a determined similarity between each of the plurality of second feature maps and the first feature map.

10. The apparatus of claim 9, wherein the product text information comprises at least one of customer company information, production area information for the product, factory information for the product, product line information for the product, process information for the product, external environment information for the product, and inspection surface information for the product.

11. The apparatus of claim 10,
wherein the customer company information comprises defect inspection standard information of a customer company, and
wherein the external environment information of the product comprises lighting condition information.

12. The apparatus of claim 9, wherein each of the plurality of candidate classes comprise information indicating whether the product is defective, and a defect type of the product.

13. The apparatus of claim 9, wherein the classifier is configured to convert the similarity between each of the plurality of second feature maps and the first feature map into a score based on a softmax function, and output a candidate class corresponding to a highest score among the converted score as a result of whether the product image is defective.

14. The apparatus of claim 9, wherein the one or more processors are further configured to:
train the image model and the text model using a plurality of training data consisting of pairs of respective training text data and training product image through a minimization of a loss calculated from a similarity between a third feature map for the training product image output from the image model and a fourth feature map for the training text data output from the text model, respectively,
wherein the training text data comprises the product text information and a ground truth label.

15. The apparatus of claim 9, wherein the one or more processors are further configured to determine a plurality of candidate classes based on decision information.

16. The apparatus of claim 15, wherein the decision information comprises defect type information and defect status information.

17. The apparatus of claim 16, wherein the user-specific product text information comprises at least one of customer company information, production area information, factory information, product line information, process information, external environment information, and inspection surface information.

18. The apparatus of claim 17, wherein the customer company information comprises defect inspection standard information of a customer company.

19. An apparatus, comprising:
processors configured to:
train an image model, using product text data and product images, to generate a first feature map;
train a text model, using the product text data, to generate a second feature map; and
train a classifier to convert a determined similarity between the first feature map and the second feature map into a class score that is indicative of whether a product is defective,
wherein the image model, the text model, and the classifier are trained together.

20. The apparatus of claim 19, wherein the product text data comprises at least one of customer company information, production area information for the product, factory information for the product, product line information for the product, process information for the product, external environment information for the product, and inspection surface information for the product.
